(19) United States
(12) Patent Application Publication
(10) Pub. No.: US 2023/0098331 A1
(43) Pub. Date: Mar. 30, 2023

(54) COMPLEX FILTER HARDWARE ACCELERATOR FOR LARGE DATA SETS

(71) Applicant: Intel Corporation, Santa Clara, CA (US)

(72) Inventors: Vinodh Gopal, Westborough, MA (US); James David Guilford, Northborough, MA (US); Otto Bruggeman, Sinsheim-Hilsbach (DE)

(73) Assignee: Intel Corporation, Santa Clara, CA (US)

(21) Appl. No.: 17/485,384

(22) Filed: Sep. 25, 2021

(51) Int. Cl. G06F 16/245

(52) U.S. Cl. CPC G06F 16/245

(57) ABSTRACT

Embodiments of apparatuses, methods, and systems for a complex filter hardware accelerator are disclosed. In an embodiment, an apparatus includes a plurality of set membership definition units and set lookup request generator hardware. Each set membership definition unit has a memory to store a definition indicator per input value. Each definition indicator is to indicate whether a corresponding input value corresponds to membership in a set. Each input value is to have a fixed width, in bits, less than an element width, in bits, of each set member. The set lookup request generator hardware is to access one of the plurality of set membership definition units. Which one of the plurality of set membership definition units to be accessed is to be determined based on an offset value. The offset value is to have an offset width, in bits, equal to the element width minus the fixed width.

### FIELD OF INVENTION

The field of invention relates generally to information processing, and, more specifically, but without limitation, to complex filtering.

### BACKGROUND

Information processing systems are increasingly being used for analytics, including querying and filtering databases to provide the basis for making decisions.

### BRIEF DESCRIPTION OF THE DRAWINGS

The present invention is illustrated by way of example and not limitation in the figures of the accompanying drawings, in which like references indicate similar elements and in which:

FIG. 1 is a diagram illustrating a method of operation of filter hardware according to an embodiment of the invention;

FIG. 2 is a diagram illustrating a method of operation of filter hardware according to an embodiment of the invention;

FIG. 3A is a block diagram of filter hardware according to an embodiment of the invention;

FIG. 3B is a diagram illustrating a method of operation of filter hardware according to an embodiment of the invention;

FIG. 4A is a block diagram illustrating both an exemplary in-order pipeline and an exemplary register renaming, out-of-order issue/execution pipeline according to embodiments of the invention;

FIG. 4B is a block diagram illustrating both an exemplary embodiment of an in-order architecture core and an exemplary register renaming, out-of-order issue/execution architecture core to be included in a processor according to embodiments of the invention;

FIG. 5 is a block diagram of a processor that may have more than one core, may have an integrated memory controller, and may have integrated graphics according to embodiments of the invention;

FIG. 6 is a block diagram of a system in accordance with one embodiment of the present invention;

FIG. 7 is a block diagram of a first more specific exemplary system in accordance with an embodiment of the present invention;

FIG. 8 is a block diagram of a second more specific exemplary system in accordance with an embodiment of the present invention; and

FIG. 9 is a block diagram of a SoC in accordance with an embodiment of the present invention.

### DETAILED DESCRIPTION

In the following description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

References to “one embodiment,” “an embodiment,” “example embodiment,” “various embodiments,” etc., indicate that the embodiment(s) of the invention so described may include particular features, structures, or characteristics, but more than one embodiment may and not every embodiment necessarily does include the particular features, structures, or characteristics. Some embodiments may have some, all, or none of the features described for other embodiments. Moreover, such phrases are not necessarily referring to the same embodiment. When a particular feature, structure, or characteristic is described in connection with an embodiment, it is submitted that it is within the knowledge of one skilled in the art to effect such feature, structure, or characteristic in connection with other embodiments whether or not explicitly described.

As used in this description and the claims and unless otherwise specified, the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

Also, the terms “bit,” “flag,” “field,” “entry,” “indicator,” etc., may be used to describe any type or content of a storage location in a register, table, database, or other data structure, whether implemented in hardware or software, but are not meant to limit embodiments of the invention to any particular type of storage location or number of bits or other elements within any particular storage location. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments of the present invention to any particular logical convention, as any logical convention may be used within embodiments of the present invention.

Also, as used in descriptions of embodiments of the invention, a “/” character between terms may mean that an embodiment may include or be implemented using, with, and/or according to the first term and/or the second term (and/or any other additional terms).

As mentioned in the background section, information processing systems are increasingly being used for analytics, including querying and filtering databases to provide the basis for making decisions. Analytics, such as real-time analytics, may benefit from techniques, such as the use of in-memory databases (IMDB), that speed up querying, filtering, and/or decision-making. Furthermore, the size of the databases may increase as data collection and/or the use of analytics grows. Therefore, it may be desirable to use embodiments of the invention to perform complex filtering and/or other operations on large data sets. Embodiments may provide for these operations to be performed more rapidly and/or at a lower total system cost than according to an existing approach, such as increasing the memory size, using software written to perform these operations on a general-purpose processor, and/or with an accelerator that is limited to operating on sets of a fixed size.

For example, according to an embodiment, an operation may be performed on a column-oriented database (i.e., structured as “column-stores”). The operation may be a query (e.g., a structured query language or “SQL” operation) such as a set-membership or other SQL or complex filter. The operation may be performed on a huge amount of data (over a full-table or numerous columns of a table) on the order of many Gigabytes. The operation may process a column and generate a predicate bit per element (or row) signifying the elements that belong to a set and may produce a small number of matching elements relative to the table size.

In this or other examples, columns may be viewed as arrays of unsigned integers of any bit-width - e.g., a column of states in the United States may be represented as an array of 6-bit elements (a dictionary encoded efficient representation since the cardinality of set of states is relatively small). An example of a complex query is when a user is interested in data from a table filtered only on some states (e.g., New England or “NE” states). The table might not have an attribute field/column in the database that indicates whether a state is a NE state, so that would be determined dynamically. If the dictionary encoding/ordering of states is alphabetical (most often the case), then such NE states are not a contiguous list of numbers but rather a seemingly disordered list of elements with gaps of varying sizes (e.g., New Hampshire, Rhode Island, Vermont), preventing the use of a simple scan for equality to one element or within a range (between a minimum and a maximum element). Instead, the query may be handled with a complex filtering operation that includes constructing a dictionary table that maps each dictionary element to a new 1-bit entry (e.g., set to ‘1’ if the corresponding state is a NE state, set to ‘0’ if not). A complex filter might process a huge column of elements using this dictionary table, checking if each element belongs in the definition set and generating a ‘1’ or ‘0’ bit output per element.

In general, a set-membership operation, involves reading each w-bit element of a column, using each w-bit element in the column to index into a lookup (e.g., dictionary) table to find a 1-bit entry, and outputting each 1-bit entry as a predicate bit per element. It is one of a variety of operations that may be performed according to embodiments. Another such operation is a find-unique operation, which populates a set (e.g., by finding all the unique values in a column) instead of checking whether element values are in a set.

Challenges in implementing complex filters to perform one or more of such operations may include: the arbitrary bit-width of the elements (e.g., from 1 bit to 32 bits) may make it difficult to find good software implementations; processing the filter with general-purpose processor cores may not be efficient due to the amount of data to be read into the cores and the need to work with elements of any bit-width serving as lookups into a table of 1-bit entries; and performing these operations with hardware accelerators using local memories may limit the element and/or dictionary set size (e.g., 15-bit element size, 32 K dictionary set size) or cause the cost of the hardware to grow proportional to set size. Embodiments may address these and other challenges to provide greater scalability, faster performance, and less cost (e.g., less area) than existing approaches.

Embodiments may include adding an extension to an existing hardware accelerator (e.g., Intel Analytics Accelerator or IAX). Performing an operation (e.g., set-membership) using the existing hardware accelerator without the extension may limit the operation to a fixed dictionary set size (2^{w}) and element size (w), but the extension may provide for using one (e.g., sequentially on a single engine/accelerator or in parallel on separate engines within a single accelerator) or more (e.g., in parallel on separate accelerators) such existing hardware accelerators to perform the operation with dictionary sets of size greater than 2^{w} and/or elements of size greater than w. For convenience, the following description may refer to an existing hardware accelerator as IAX, 2^{w} as 32 K, and/or w as 15 bits; however, embodiments may include the use of any existing hardware accelerator having any value of 2^{w} and/or w.

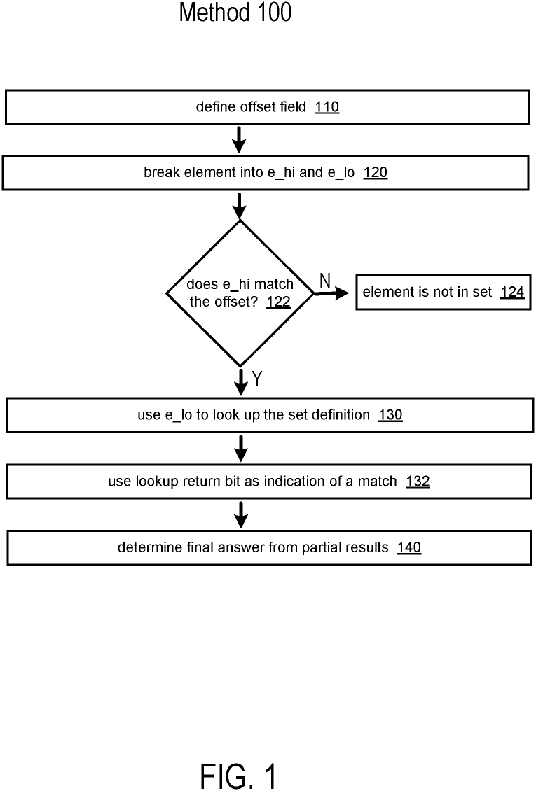

In embodiments, at the application programming interface (API) level, a set-membership function may be performed with a call to a hardware accelerator. The call may provide a pointer to column data and may also specify the size of the column in terms of number of elements and the bit width of the elements. The call may also provide a pointer to a bit vector, or dictionary set, that is used to indicate which element values correspond to a match. In embodiments, a “1” on the i^{th} bit (i = 0 to 2^{w}-1) of the bit vector means an element whose value is i is considered a match (e.g., that element value is in the set). Using only IAX may limit the set size to 32 K elements and/or the element width to 15 bits, resulting in an error if a different element width (or set size) is specified. However, embodiments (e.g., using an extension to IAX) may provide for the same function to be called with a different (e.g., greater) element width (or set size) without growing the size of the internal memories, as illustrated by example in FIG. 1.

FIG. 1 is a diagram illustrating method 100, an example of a portion of a method of operation of a filter hardware accelerator according to an embodiment.

In block 110 of method 100, a new field (e.g., 32-bits) called offset is defined. The offset field is used when the element size is larger than a fixed width. For example, with an element size of 17 bits, view the set as four smaller equi-sized subsets S1, S2, S3, S4, each having 2¹⁵ members, with a unique 2-bit offset per subset. In this example, four separate IAX jobs may be prepared to run in parallel:
w=17, src1=column, src2=S1, offset=0b00, dest=bv1
w=17, src1=column, src2=S2, offset=0b01, dest=bv2
w=17, src1=column, src2=S3, offset=0b10, dest=bv3
w=17, src1=column, src2=S4, offset=0b11, dest=bv4

In block 120, to check if an element e belongs in the set, e is broken into e_hi and e_lo such that e_lo is the fixed width (e.g., 15 bits).

In block 122, it is determined whether e_hi matches the offset. If not, then in 124, element e does not belong in the set (e.g., set predicate bit to ‘0’). If so, method 100 continues to block 130.

In block 130, e_lo is used to look up the set definition for the corresponding subset (e.g., in a set table in local memory). In block 132, the bit returned by the lookup is used as an indication of match for element e (e.g., set predicate bit to value of returned bit).

In block 140, when all the results for each offset are known, the final answer is a bitwise OR of the partial results. For example, the final answer to the query described above is given by the bit-vector:

$$\text{bv} = \text{bv1} \left|\text{bv2} \left|\text{bv3} \left|\text{bv4}\right)\right)\right)$$

Thus, jobs may be sent to parallel engines inside a single existing accelerator (e.g., IAX) or across the multiple accelerators, thus executing in approximately the same time as with a smaller dictionary set (e.g., with 2¹⁵ members). For example, with four accelerators, each with eight engines, 32 jobs may be executed in parallel, such that embodiments with the described extension (i.e., using an offset) may support a dictionary with 2²⁰ members at approximately the same speed as a with an existing accelerator without the extension.

Furthermore, even larger dictionary sets may be supported with a combination of parallel and sequential execution. For example, for a dictionary set with 2²¹ members, two batches of jobs may be prepared and run sequentially (on the same hardware as described above):
32 jobs with offsets 0-31 executed in parallel
32 jobs with offsets 32-63 executed in parallel after previous batch completion

In such an embodiment, memory bandwidth usage may be optimized by bringing (e.g., with software) the column data into caches (e.g., last level cache or LLC) before submitting the batch of jobs, since they all read the same column data source. In an embodiment in which the column is deflate compressed, a first job may be run to decompress the column into an LLC, then a batch of parallel filter jobs may be run to read the uncompressed column.

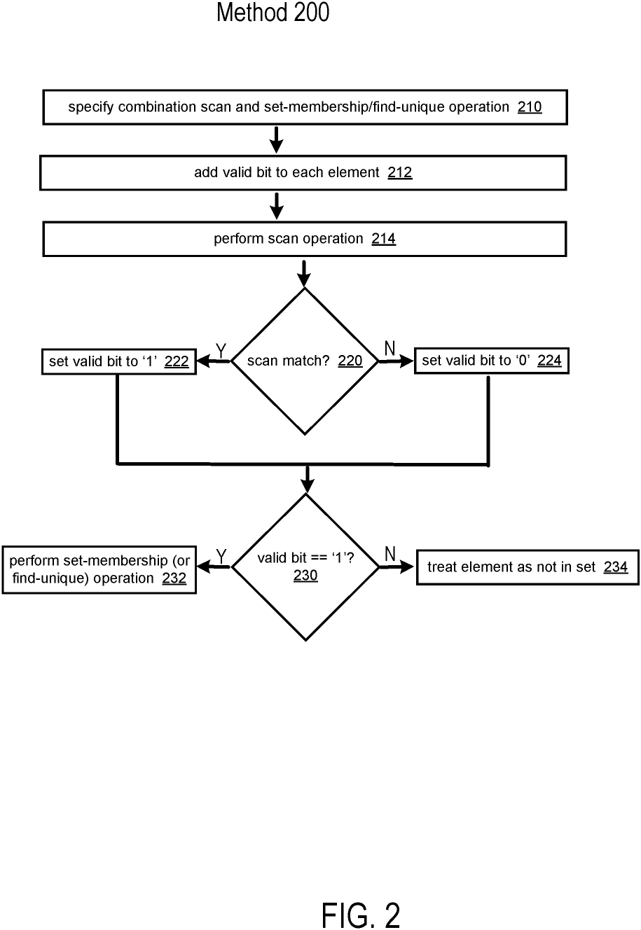

In embodiments, an equivalent but slightly more generalized approach may be used to solve large set-membership/find-unique problems. Conceptually, this approach fuses a scan operation with a set-member, find-unique, or other operation that is conditionally performed based on the element scan. This approach may provide more flexibility and/or extensibility. Method 200, an example of a portion of such an embodiment, is shown in FIG. 2.

In block 210 of method 200, a new call/instruction/opcode/mode is added to specify that a combination of a scan operation and set-membership/find-unique operation is to be performed. In other words, only the elements that lie in the range defined by the parameters (e.g., specified by the call/instruction) are processed.

In block 212, a “valid bit” is added to each element to be looked up.

In block 214, a scan operation checks each element for a variety of conditions such as that the element value matches a specified value (elem == val1) or that the element value is between two specified values (val1 <= elem <= val2). Scans may be performed by arithmetic -logic units (ALUs) so that element sizes up to the ALU size (e.g., 32 bits) may be processed without increasing the memory size.

In block 220, (for each element) the valid bit is set to indicate whether the element matches the scan parameters (e.g., in block 222, set the valid bit to ‘1’ if element value matches the specified value or is within the specified range, otherwise, on block 224, set the valid bit to ‘0’).

In block 230, (for each element) the valid bit is checked to determine if the second operation of the two combined operations is to be performed. If the element is valid (e.g., valid bit is ‘1’), then in block 232 a set-membership, find-unique, or other operation (e.g., as described above). If not (e.g., valid bit is ‘0’), then the element is treated as if the element is not in the set (e.g., marked as not present in the set if the second operation is a set-membership lookup, not used to set a corresponding bit in a set-mem table (as defined below) if the second operation is a find-unique operation, etc.).

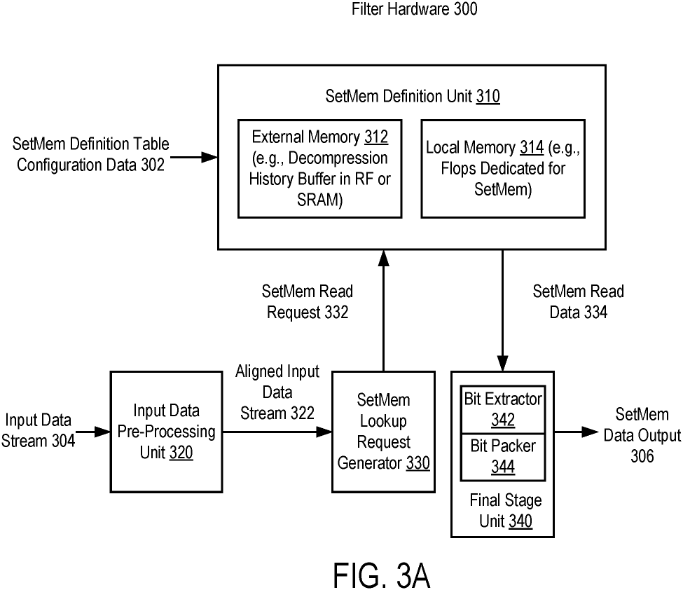

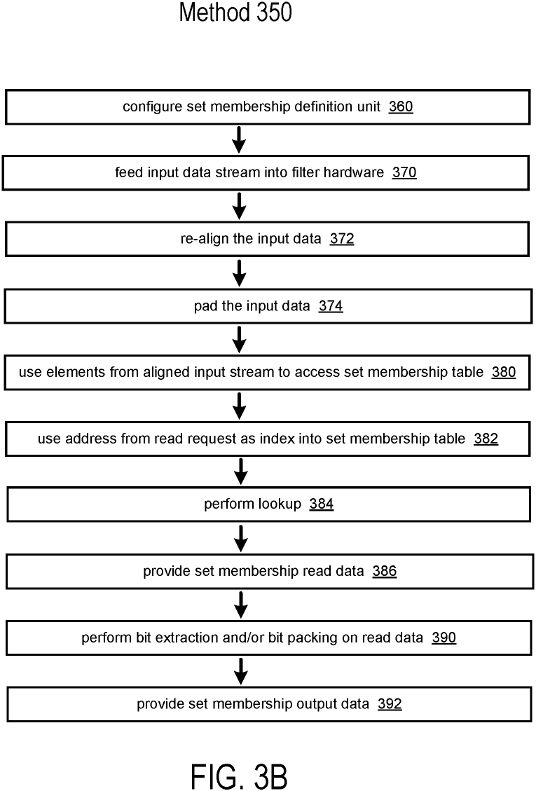

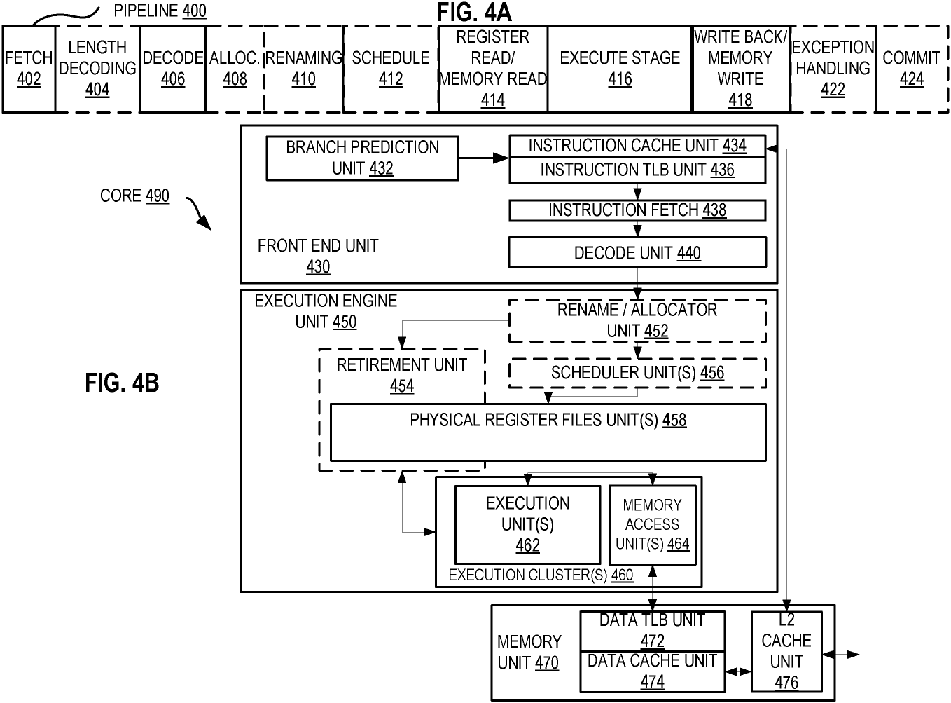

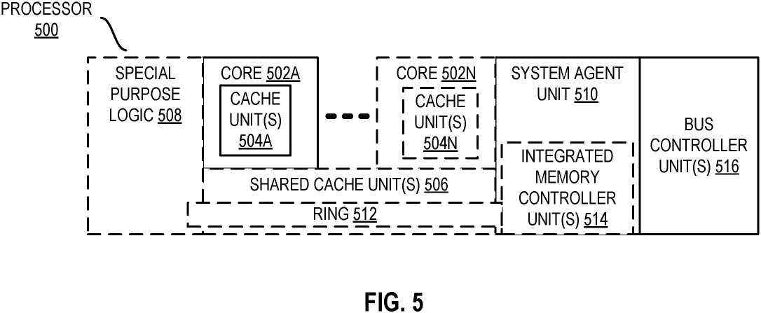

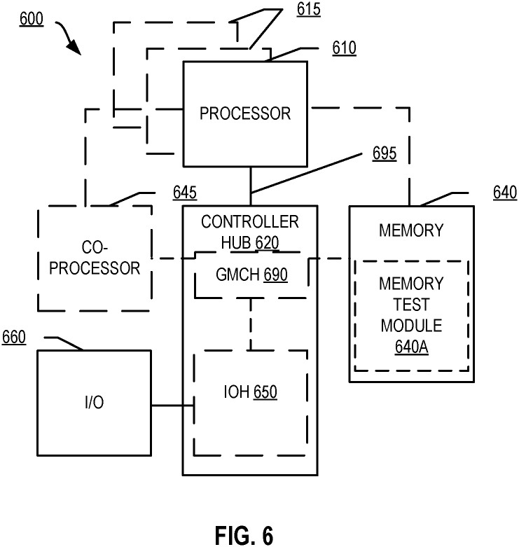

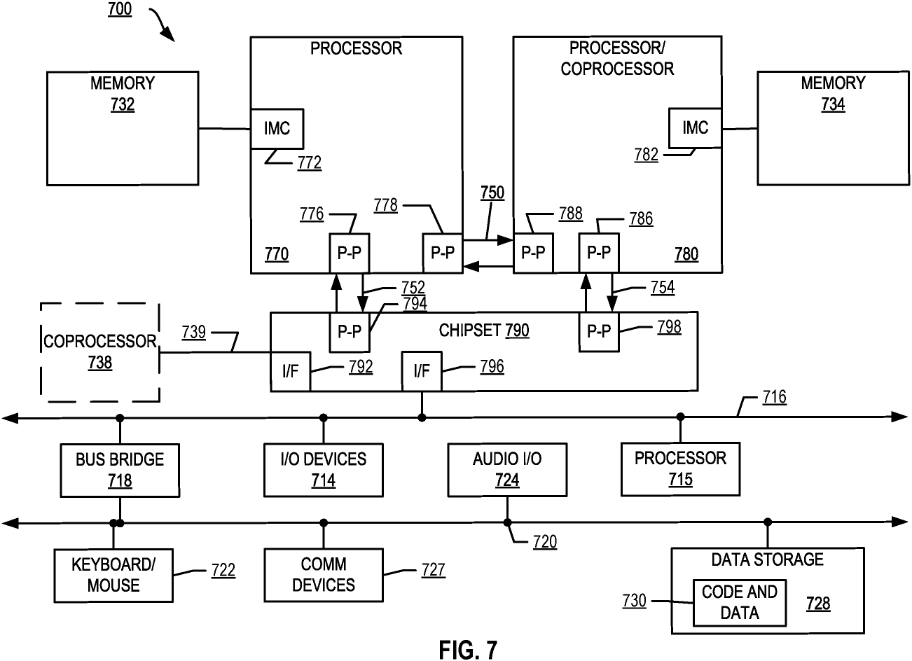

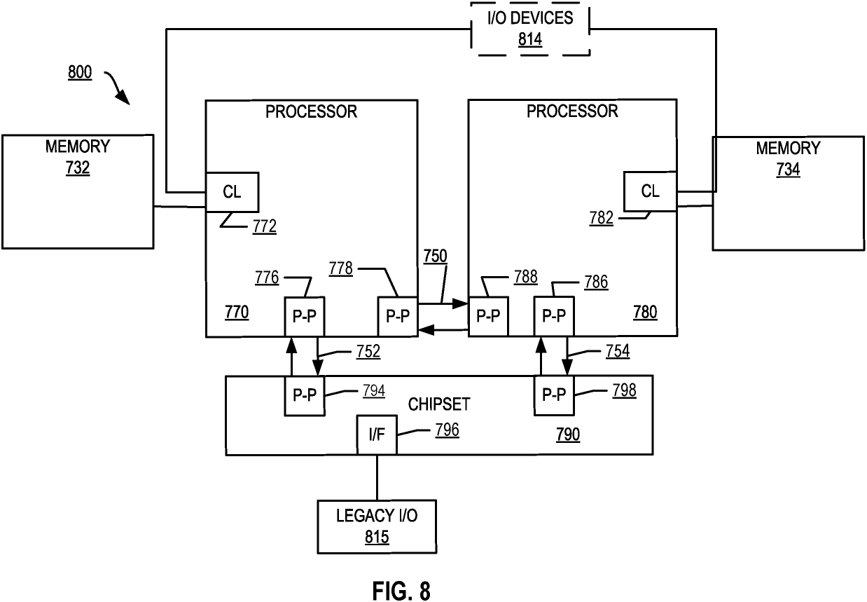

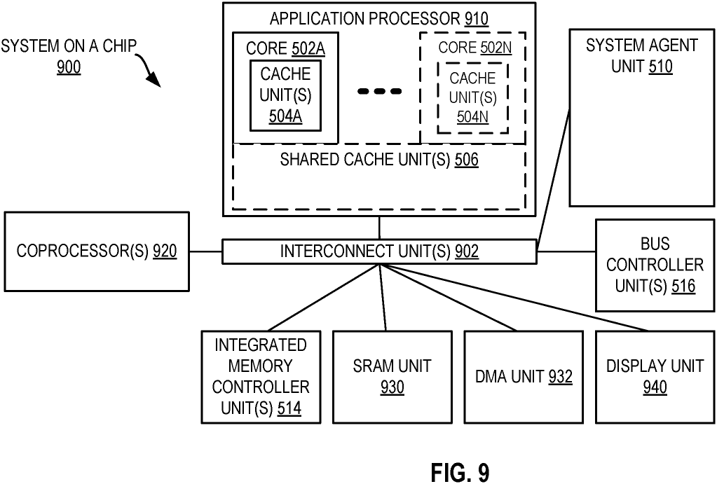

FIG. 3A is a block diagram of filter hardware 300 according to embodiments. The apparatus shown in FIG. 3 may be implemented in logic gates and/or any other type of circuitry, all or parts of which may be integrated into the circuitry of a processing device or any other apparatus in a computer or other information processing system. For example, any or all of the hardware shown in FIG. 3 may be implemented in any of core 490 in FIG. 4B, cores 502A to 502N in FIG. 5, special purpose logic 508 in FIG. 5, processors 610/615 in FIG. 6, co-processor 645 in FIG. 6, processors 770/780 in FIGS. 7 and 8, co-processor 738 in FIG. 7, application processor 910 in FIG. 9, and/or co-processor 920 in FIG. 9, each as described below.

As shown in FIG. 3A, filter hardware 300 includes set-mem definition unit 310, input data pre-processing unit 320, set-mem lookup request generator 330, and final stage unit 340. In various embodiments, filter hardware may include one or more of any or all of the blocks shown in FIG. 3A. For example, filter hardware in an embodiment capable of handling queries with dictionary set having 2¹⁷ members (as described in the example above) may include four instances of set-mem definition unit 310, each to store a subset corresponding to one of four different offsets. Furthermore, arrows such as set-mem read request 332 may represent one of many set-mem read requests performed in a method embodiment such as method 350 as described below.

FIG. 3B is a flow diagram of method 350, an example of a portion of a method of operation of a filter hardware accelerator according to an embodiment, which may be used to illustrate the operation of one or more units, elements, blocks, etc. of filter hardware according to embodiments such as that shown in FIG. 3A. The numbering and arrows in FIG. 3B are for ease of description and do not necessarily require particular ordering, sequencing, or correspondence of blocks and/or items. For example, set-mem lookup request generator 330 may issue any number of set-mem read requests 332 to a single or any number of set-mem definition units 310 based on a single input data stream 304.

As shown in FIG. 3A, set-mem definition unit 310 may include external memory 322 and/or local memory 324 to store a table or other data structure to define a set. For example, external memory 312 may represent a decompression history buffer in a register file (RF) or static random-access memory (SRAM), and/or local memory 314 may represent flip-flops dedicated to store set definitions. The table or other data structure (for convenience, it will be referred to as a set-mem table but may be a bit vector or other data structure) stores the set of members that matches the predicate being applied (e.g., the definition set). For example, it may be a dictionary table with, for every possible value of the column data (up to a fixed width, e.g., 15 bits), a definition bit to indicate whether the value is a member of the definition set; thus, for 15-bit elements, there are 2¹⁵ bits of storage in the set-mem table. If the element size is greater than the fixed width, the set-mem table represents a subset given by the offset number.

In method block 360, set-mem definition table configuration data 302 is provided to set-mem definition unit 310 to configure/program set-mem definition unit with the set definition.

In method block 370, input data stream 304 is fed into filter hardware 300. Input data pre-processing unit 320 may include column data input re-alignment logic to perform transformations on input data stream 304. For example, in method block 372, input data pre-processing unit 320 may re-align the input data so that each element falls into a proper lane, and/or, in method block 374, input data pre-processing unit 320 may prepend zeroes (i.e., pad with zeroes, e.g., at the high order end) to each element to match the lane width.

In method block 380, set-mem lookup request generator 330 uses elements from the aligned input data stream 322 to access the set-mem table. Since input data pre-processing unit 320 has already aligned and zero-padded each element to the proper lanes, each element may be extracted and used as an address to issue a set-mem read request 332 to set-mem definition table 310.

In method block 382, an address from a set-mem table read request is used as in index into a set-mem table in a set-mem definition unit 310, to look up a corresponding definition bit. In method block 384, the lookup is performed. In method block 386, set-mem read data 334 (e.g., a predicate bit indicating whether the element corresponding to the read request is a member of the set) is provided to final stage unit 340.

Set-mem read data 334 may be provided as a stream of bits, which may be efficiently processed and stored based on a particular size (e.g., a word size of 16 bits or more). Therefore, in method block 390, final stage unit 340 may perform bit extraction (e.g., with bit extractor 346) and/or bit packing (e.g., with bit packer 344).

In method block 392, final stage unit 340 provides set-mem output data 306, which may represent a result bit-vector such as “bv” as described above, or any one of “bv1”, “bv2”, “bv3”, or “bv4” as described above and to be further processed according to embodiments to provide the final result bit vector “bv” as described above.

In embodiments, an apparatus includes a plurality of set membership definition units and set lookup request generator hardware. Each set membership definition unit has a memory to store a definition indicator per input value. Each definition indicator is to indicate whether a corresponding input value corresponds to membership in a set. Each input value is to have a fixed width, in bits, less than an element width, in bits, of each set member. The set lookup request generator hardware is to access one of the plurality of set membership definition units. Which one of the plurality of set membership definition units to be accessed is to be determined based on an offset value. The offset value is to have an offset width, in bits, equal to the element width minus the fixed width.

Any such embodiments may include any or any combination of the following aspects. The set lookup request generator hardware may be to generate a request to the one of the plurality of set membership definition units with an address equal to the corresponding input value. The request may be to read the corresponding definition indicator. The request may be to set the corresponding definition indicator. The apparatus may also include input data processing hardware to perform a transformation on an input data stream to provide the address for the request. The transformation may include aligning a portion of the input data stream to a lane. The transformation may include prepending zeroes to a portion of the input data stream. The apparatus may also include output data processing hardware to perform output processing on output data from at least the one of the plurality of set membership definition units, wherein the output data is to include a result of the request. The output processing may include bit extraction. The output processing may include bit packing.

In embodiments, a method includes configuring a plurality of set membership definition units, each set membership definition unit having a memory to store a definition indicator per input value, each definition indicator to indicate whether a corresponding input value corresponds to membership in a set, wherein each input value is to have a fixed width, in bits, less than an element width, in bits, of each set member; and accessing one of the plurality of set membership definition units, wherein which one of the plurality of set membership definition units to be accessed is to be determined based on an offset value, wherein the offset value is to have an offset width, in bits, equal to the element width minus the fixed width.

Any such embodiments may include any or any combination of the following aspects. The accessing may include generating a request to the one of the plurality of set membership definition units with an address equal to the corresponding input value. The request may be to read the corresponding definition indicator. The request may be to set the corresponding definition indicator. The method may also include performing a transformation on an input data stream to provide the address for the request, wherein the transformation includes at least one of aligning a portion of the input data stream to a lane and prepending zeroes to a portion of the input data stream. The method may also include performing output processing on output data from at least the one of the plurality of set membership definition units, wherein the output data is to include a result of the request and wherein the output processing includes at least one of bit extraction and bit packing.

In embodiments, non-transitory machine-readable medium stores instructions which, when executed by a machine, cause the machine to perform a method comprising configuring a plurality of set membership definition units, each set membership definition unit having a memory to store a definition indicator per input value, each definition indicator to indicate whether a corresponding input value corresponds to membership in a set, wherein each input value is to have a fixed width, in bits, less than an element width, in bits, of each set member; and accessing one of the plurality of set membership definition units, wherein which one of the plurality of set membership definition units to be accessed is to be determined based on an offset value, wherein the offset value is to have an offset width, in bits, equal to the element width minus the fixed width.

Any such embodiments may include any or any combination of the following aspects. The accessing may include generating a request to the one of the plurality of set membership definition units with an address equal to the corresponding input value. The request may be to read the corresponding definition indicator. The request may be to set the corresponding definition indicator.

In embodiments, an apparatus may include means for performing any function disclosed herein. In embodiments, an apparatus may include a data storage device that stores code that when executed by a hardware processor causes the hardware processor to perform any method disclosed herein. In embodiments, an apparatus may be as described in the detailed description. In embodiments, a method may be as described in the detailed description. In embodiments, a non-transitory machine-readable medium may store code that when executed by a machine causes the machine to perform a method including any method disclosed herein. Embodiments may include any details, features, etc. or combinations of details, features, etc. described in this specification.

### Exemplary Core Architectures, Processors, and Computer Architectures

The figures below detail exemplary architectures and systems to implement embodiments of the above.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-Of-Order Core Block Diagram

FIG. 4A is a block diagram illustrating both an exemplary in-order pipeline and an exemplary register renaming, out-of-order issue/execution pipeline according to embodiments of the invention. FIG. 4B is a block diagram illustrating both an exemplary embodiment of an in-order architecture core and an exemplary register renaming, out-of-order issue/execution architecture core to be included in a processor according to embodiments of the invention. The solid lined boxes in FIGS. 4A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 4A, a processor pipeline 400 includes a fetch stage 402, a length decode stage 404, a decode stage 406, an allocation stage 408, a renaming stage 410, a scheduling (also known as a dispatch or issue) stage 412, a register read/memory read stage 414, an execute stage 416, a write back/memory write stage 418, an exception handling stage 422, and a commit stage 424.

FIG. 4B shows processor core 490 including a front-end unit 430 coupled to an execution engine unit 450, and both are coupled to a memory unit 470. The core 490 may be a reduced instruction set computing (RISC) core, a complex instruction set computing (CISC) core, a very long instruction word (VLIW) core, or a hybrid or alternative core type. As yet another option, the core 490 may be a special-purpose core, such as, for example, a network or communication core, compression engine, coprocessor core, general purpose computing graphics processing unit (GPGPU) core, graphics core, or the like.

The front-end unit 430 includes a branch prediction unit 432, which is coupled to an instruction cache unit 434, which is coupled to an instruction translation lookaside buffer (TLB) 436, which is coupled to an instruction fetch unit 438, which is coupled to a decode unit 440. The decode unit 440 (or decoder) may decode instructions, and generate as an output one or more micro-operations, micro-code entry points, microinstructions, other instructions, or other control signals, which are decoded from, or which otherwise reflect, or are derived from, the original instructions. The decode unit 440 may be implemented using various different mechanisms. Examples of suitable mechanisms include, but are not limited to, look-up tables, hardware implementations, programmable logic arrays (PLAs), microcode read only memories (ROMs), etc. In one embodiment, the core 490 includes a microcode ROM or other medium that stores microcode for certain macroinstructions (e.g., in decode unit 440 or otherwise within the front-end unit 430). The decode unit 440 is coupled to a rename/allocator unit 452 in the execution engine unit 450.

The execution engine unit 450 includes the rename/allocator unit 452 coupled to a retirement unit 454 and a set of one or more scheduler unit(s) 456. The scheduler unit(s) 456 represents any number of different schedulers, including reservations stations, central instruction window, etc. The scheduler unit(s) 456 is coupled to the physical register file(s) unit(s) 458. Each of the physical register file(s) units 458 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 458 comprises a vector registers unit, a write mask registers unit, and a scalar registers unit. These register units may provide architectural vector registers, vector mask registers, and general-purpose registers. The physical register file(s) unit(s) 458 is overlapped by the retirement unit 454 to illustrate various ways in which register renaming and out-of-order execution may be implemented (e.g., using a reorder buffer(s) and a retirement register file(s); using a future file(s), a history buffer(s), and a retirement register file(s); using a register map and a pool of registers; etc.). The retirement unit 454 and the physical register file(s) unit(s) 458 are coupled to the execution cluster(s) 460. The execution cluster(s) 460 includes a set of one or more execution units 462 and a set of one or more memory access units 464. The execution units 462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 456, physical register file(s) unit(s) 458, and execution cluster(s) 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster - and in the case of a separate memory access pipeline, certain embodiments are implemented in which only the execution cluster of this pipeline has the memory access unit(s) 464). It should also be understood that where separate pipelines are used, one or more of these pipelines may be out-of-order issue/execution and the rest in-order.

The set of memory access units 464 is coupled to the memory unit 470, which includes a data TLB unit 472 coupled to a data cache unit 474 coupled to a level 2 (L2) cache unit 476. In one exemplary embodiment, the memory access units 464 may include a load unit, a store address unit, and a store data unit, each of which is coupled to the data TLB unit 472 in the memory unit 470. The instruction cache unit 434 is further coupled to a level 2 (L2) cache unit 476 in the memory unit 470. The L2 cache unit 476 is coupled to one or more other levels of cache and eventually to a main memory.

By way of example, the exemplary register renaming, out-of-order issue/execution core architecture may implement the pipeline 400 as follows: 1) the instruction fetch 438 performs the fetch and length decoding stages 402 and 404; 2) the decode unit 440 performs the decode stage 406; 3) the rename/allocator unit 452 performs the allocation stage 408 and renaming stage 410; 4) the scheduler unit(s) 456 performs the schedule stage 412; 5) the physical register file(s) unit(s) 458 and the memory unit 470 perform the register read/memory read stage 414; the execution cluster 460 perform the execute stage 416; 6) the memory unit 470 and the physical register file(s) unit(s) 458 perform the write back/memory write stage 418; 7) various units may be involved in the exception handling stage 422; and 8) the retirement unit 454 and the physical register file(s) unit(s) 458 perform the commit stage 424.

The core 490 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 434/474 and a shared L2 cache unit 476, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5 is a block diagram of a processor 500 that may have more than one core, may have an integrated memory controller, and may have integrated graphics according to embodiments of the invention. The solid lined boxes in FIG. 5 illustrate a processor 500 with a single core 502A, a system agent 510, a set of one or more bus controller units 516, while the optional addition of the dashed lined boxes illustrates an alternative processor 500 with multiple cores 502A-N, a set of one or more integrated memory controller unit(s) 514 in the system agent unit 510, and special purpose logic 508.

Thus, different implementations of the processor 500 may include: 1) a CPU with the special purpose logic 508 being integrated graphics and/or scientific (throughput) logic (which may include one or more cores), and the cores 502A-N being one or more general purpose cores (e.g., general purpose in-order cores, general purpose out-of-order cores, a combination of the two); 2) a coprocessor with the cores 502A-N being a large number of special purpose cores intended primarily for graphics and/or scientific (throughput); and 3) a coprocessor with the cores 502A-N being a large number of general purpose in-order cores. Thus, the processor 500 may be a general-purpose processor, coprocessor, or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 506, and external memory (not shown) coupled to the set of integrated memory controller units 514. The set of shared cache units 506 may include one or more mid-level caches, such as level 2 (L2), level 3 (L3), level 4 (L4), or other levels of cache, a last level cache (LLC), and/or combinations thereof. While in one embodiment a ring-based interconnect unit 512 interconnects the integrated graphics logic 508 (integrated graphics logic 508 is an example of and is also referred to herein as special purpose logic), the set of shared cache units 506, and the system agent unit 510/integrated memory controller unit(s) 514, alternative embodiments may use any number of well-known techniques for interconnecting such units. In one embodiment, coherency is maintained between one or more cache units 506 and cores 502A-N.

In some embodiments, one or more of the cores 502A-N are capable of multi-threading. The system agent 510 includes those components coordinating and operating cores 502A-N. The system agent unit 510 may include for example a power control unit (PCU) and a display unit. The PCU may be or include logic and components needed for regulating the power state of the cores 502A-N and the integrated graphics logic 508. The display unit is for driving one or more externally connected displays.

The cores 502A-N may be homogenous or heterogeneous in terms of architecture instruction set; that is, two or more of the cores 502A-N may be capable of execution the same instruction set, while others may be capable of executing only a subset of that instruction set or a different instruction set.

### Exemplary Computer Architectures

FIGS. 6-9 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a huge variety of systems or electronic devices capable of incorporating a processor and/or other execution logic as disclosed herein are generally suitable.

Referring now to FIG. 6, shown is a block diagram of a system 600 in accordance with one embodiment of the present invention. The system 600 may include one or more processors 610, 615, which are coupled to a controller hub 620. In one embodiment, the controller hub 620 includes a graphics memory controller hub (GMCH) 690 and an Input/Output Hub (IOH) 650 (which may be on separate chips); the GMCH 690 includes memory and graphics controllers to which are coupled memory 640 and a coprocessor 645; the IOH 650 couples input/output (I/O) devices 660 to the GMCH 690. Alternatively, one or both of the memory and graphics controllers are integrated within the processor (as described herein), the memory 640 and the coprocessor 645 are coupled directly to the processor 610, and the controller hub 620 in a single chip with the IOH 650.

The optional nature of additional processors 615 is denoted in FIG. 6 with broken lines. Each processor 610, 615 may include one or more of the processing cores described herein and may be some version of the processor 500.

The memory 640 may be, for example, dynamic random-access memory (DRAM), phase change memory (PCM), or a combination of the two. For at least one embodiment, the controller hub 620 communicates with the processor(s) 610, 615 via a multi-drop bus, such as a frontside bus (FSB), point-to-point interface such as QuickPath Interconnect (QPI), or similar connection 695.

In one embodiment, the coprocessor 645 is a special-purpose processor, such as, for example, a high-throughput MIC processor, a network or communication processor, compression engine, graphics processor, GPGPU, embedded processor, or the like. In one embodiment, controller hub 620 may include an integrated graphics accelerator.

There can be a variety of differences between the physical resources 610, 615 in terms of a spectrum of metrics of merit including architectural, microarchitectural, thermal, power consumption characteristics, and the like.

In one embodiment, the processor 610 executes instructions that control data processing operations of a general type. Embedded within the instructions may be coprocessor instructions. The processor 610 recognizes these coprocessor instructions as being of a type that should be executed by the attached coprocessor 645. Accordingly, the processor 610 issues these coprocessor instructions (or control signals representing coprocessor instructions) on a coprocessor bus or other interconnect, to coprocessor 645. Coprocessor(s) 645 accept and execute the received coprocessor instructions.

Referring now to FIG. 7, shown is a block diagram of a first more specific exemplary system 700 in accordance with an embodiment of the present invention. As shown in FIG. 7, multiprocessor system 700 is a point-to-point interconnect system, and includes a first processor 770 and a second processor 780 coupled via a point-to-point interconnect 750. Each of processors 770 and 780 may be some version of the processor 500. In one embodiment of the invention, processors 770 and 780 are respectively processors 610 and 615, while coprocessor 738 is coprocessor 645. In another embodiment, processors 770 and 780 are respectively processor 610 and coprocessor 645.

Processors 770 and 780 are shown including integrated memory controller (IMC) units 772 and 782, respectively. Processor 770 also includes as part of its bus controller unit’s point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may optionally exchange information with the coprocessor 738 via a high-performance interface 792. In one embodiment, the coprocessor 738 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors’ local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present invention is not so limited.

As shown in FIG. 7, various I/O devices 714 may be coupled to first bus 716, along with a bus bridge 718 which couples first bus 716 to a second bus 720. In one embodiment, one or more additional processor(s) 715, such as coprocessors, high-throughput MIC processors, GPGPU’s, accelerators (such as, e.g., graphics accelerators or digital signal processing (DSP) units), field programmable gate arrays, or any other processor, are coupled to first bus 716. In one embodiment, second bus 720 may be a low pin count (LPC) bus. Various devices may be coupled to a second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to the second bus 720. Note that other architectures are possible. For example, instead of the point-to-point architecture of FIG. 7, a system may implement a multi-drop bus or other such architecture.

Referring now to FIG. 8, shown is a block diagram of a second more specific exemplary system 800 in accordance with an embodiment of the present invention. Like elements in FIGS. 7 and 8 bear like reference numerals, and certain aspects of FIG. 7 have been omitted from FIG. 8 in order to avoid obscuring other aspects of FIG. 8.

FIG. 8 illustrates that the processors 770, 780 may include integrated memory and I/O control logic (“CL”) 772 and 782, respectively. Thus, the CL 772, 782 include integrated memory controller units and include I/O control logic. FIG. 8 illustrates that not only are the memories 732, 734 coupled to the CL 772, 782, but also that I/O devices 814 are also coupled to the control logic 772, 782. Legacy I/O devices 815 are coupled to the chipset 790.

Referring now to FIG. 9, shown is a block diagram of a SoC 900 in accordance with an embodiment of the present invention. Similar elements in FIG. 5 bear like reference numerals. Also, dashed lined boxes are optional features on more advanced SoCs. In FIG. 9, an interconnect unit(s) 902 is coupled to: an application processor 910 which includes a set of one or more cores 502A-N, which include cache units 504A-N, and shared cache unit(s) 506; a system agent unit 510; a bus controller unit(s) 516; an integrated memory controller unit(s) 514; a set or one or more coprocessors 920 which may include integrated graphics logic, an image processor, an audio processor, and a video processor; a static random access memory (SRAM) unit 930; a direct memory access (DMA) unit 932; and a display unit 940 for coupling to one or more external displays. In one embodiment, the coprocessor(s) 920 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 730 illustrated in FIG. 7, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations (known as “IP cores”) may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In this specification, operations in flow diagrams may have been described with reference to exemplary embodiments of other figures. However, it should be understood that the operations of the flow diagrams may be performed by embodiments of the invention other than those discussed with reference to other figures, and the embodiments of the invention discussed with reference to other figures may perform operations different than those discussed with reference to flow diagrams. Furthermore, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. An apparatus comprising:
a plurality of set membership definition units, each set membership definition unit having a memory to store a definition indicator per input value, each definition indicator to indicate whether a corresponding input value corresponds to membership in a set, wherein each input value is to have a fixed width, in bits, less than an element width, in bits, of each set member; and
set lookup request generator hardware to access one of the plurality of set membership definition units, wherein which one of the plurality of set membership definition units to be accessed is to be determined based on an offset value, wherein the offset value is to have an offset width, in bits, equal to the element width minus the fixed width.

2. The apparatus of claim 1, wherein the set lookup request generator hardware is to generate a request to the one of the plurality of set membership definition units with an address equal to the corresponding input value.

3. The apparatus of claim 2, wherein the request is to read the corresponding definition indicator.

4. The apparatus of claim 2, wherein the request is to set the corresponding definition indicator.

5. The apparatus of claim 2, further comprising input data processing hardware to perform a transformation on an input data stream to provide the address for the request.

6. The apparatus of claim 5, wherein the transformation is to include aligning a portion of the input data stream to a lane.

7. The apparatus of claim 5, wherein the transformation is to include prepending zeroes to a portion of the input data stream.

8. The apparatus of claim 2, further comprising output data processing hardware to perform output processing on output data from at least the one of the plurality of set membership definition units, wherein the output data is to include a result of the request.

9. The apparatus of claim 8, wherein the output processing includes bit extraction.

10. The apparatus of claim 8, wherein the output processing includes bit packing.

11. A method comprising:
configuring a plurality of set membership definition units, each set membership definition unit having a memory to store a definition indicator per input value, each definition indicator to indicate whether a corresponding input value corresponds to membership in a set, wherein each input value is to have a fixed width, in bits, less than an element width, in bits, of each set member; and
accessing one of the plurality of set membership definition units, wherein which one of the plurality of set membership definition units to be accessed is to be determined based on an offset value, wherein the offset value is to have an offset width, in bits, equal to the element width minus the fixed width.

12. The method of claim 11, wherein the accessing includes generating a request to the one of the plurality of set membership definition units with an address equal to the corresponding input value.

13. The method of claim 12, wherein the request is to read the corresponding definition indicator.

14. The method of claim 12, wherein the request is to set the corresponding definition indicator.

15. The method of claim 12, further comprising performing a transformation on an input data stream to provide the address for the request, wherein the transformation includes at least one of aligning a portion of the input data stream to a lane and prepending zeroes to a portion of the input data stream.

16. The method of claim 12, further comprising performing output processing on output data from at least the one of the plurality of set membership definition units, wherein the output data is to include a result of the request and wherein the output processing includes at least one of bit extraction and bit packing.

17. A non-transitory machine-readable medium storing instructions which, when executed by a machine, cause the machine to perform a method comprising:
configuring a plurality of set membership definition units, each set membership definition unit having a memory to store a definition indicator per input value, each definition indicator to indicate whether a corresponding input value corresponds to membership in a set, wherein each input value is to have a fixed width, in bits, less than an element width, in bits, of each set member; and
accessing one of the plurality of set membership definition units, wherein which one of the plurality of set membership definition units to be accessed is to be determined based on an offset value, wherein the offset value is to have an offset width, in bits, equal to the element width minus the fixed width.

18. The medium of claim 17, wherein the accessing includes generating a request to the one of the plurality of set membership definition units with an address equal to the corresponding input value.

19. The medium of claim 18, wherein the request is to read the corresponding definition indicator.

20. The medium of claim 18, wherein the request is to set the corresponding definition indicator.
